(19) United States
(12) Patent Application Publication
(10) Pub. No.: US 2011/0276419 A1
(43) Pub. Date: Nov. 10, 2011

(54) SYSTEM AND METHOD FOR PAYMENT BETWEEN A HAND HELD` DEVICE AND A MERCHANT DEVICE

(76) Inventors: Craig Johnson, McKinney, TX (US); Landon Robinson, Douglasville, GA (US)

(21) Appl. No.: 12/777,247

(22) Filed: May 10, 2010

(51) Int. Cl. G06Q 20/00; G08B 5/22; G06Q 10/00; G06Q 40/00; G06K 5/00; G06Q 30/00

(52) U.S. Cl. 705/17; 235/380; 705/21; 705/346

(57) ABSTRACT

A system which has a hand held device with an application program. The hand held device allows a merchant device to locate the hand held device. The merchant device has an application program wherein the merchant device allows the merchant device to locate the hand held device. The merchant device provides a charge and the hand held device provides a payment for the charge.

### TECHNICAL FIELD OF THE INVENTION

This invention relates to a system and method for payment using a hand held device, in particular, to a system and method where the hand held device communicates with a merchant device for payment.

### BACKGROUND OF THE INVENTION

The credit card has emerged nowadays to an indispensable item of everyday life, and the frequency and extent of its use are rapidly expanding, so that most credit card users carry three to four credit cards in their purses. Although the merit of a credit card is tremendous in that it exempts a user from the burden of carrying currency, but it can also generate various troubles once it gets lost or is stolen.

According to a statistic, an average card user loses two or more credit cards in a year. In view of this statistic, the waste in time and costs for reissuing the credit cards lost or stolen grows enormous for the whole society. Furthermore, a credit card stores information necessary for a payment procedure in the magnetic band attached on the rear side thereof, allowing a credit card-reader device to acquire this information by reading the band. Another problem with the credit card is that its magnetic band can easily be damaged. Once the magnetic band is damaged, the credit card is normally reissued, causing additional waste in time and costs. On the other hand, mobile phones have recently been so rapidly widespread that most users carry one or more mobile phones with them. Payments for commercial trades using a mobile phone are performed on the Internet usually for small amounts, and the purchase invoices are issued combined with the invoices for the mobile phone fees. Thus, there has been a demand for a system, which allows a user to achieve an effect by using his mobile phone, which is now owned by most users, comparable to the effect of a credit card.

Another disadvantage of using a credit card is the amount of time a consumer and merchant spend during the purchase. A customer must pay and the merchant must use a payment device to charge the customer. Given the fast paced world, it is a huge benefit to the consumer if he/she can save time by not having to spend extra time to purchase the goods and/or services. Thus, it is preferable that the consumer can rapidly pay for their consumer goods/or services.

Consequently, there is a need for methods and systems to enable merchants and customers to request and receive payment in exchange for goods, services, or other values. There is also a need for methods and systems to enable merchants to receive payment authorization immediately and/or simultaneously with the commercial transaction conducted at a location.

### SUMMARY OF THE INVENTION

The present invention is a system comprising i.) a hand held device having an application program wherein the hand held device allows a merchant device to locate the hand held device and a ii.) merchant device having an application program wherein the merchant device allows the merchant device to locate the hand held device.

The system can also have a merchant device which locates the hand held device through wireless communication.

The system can also have a wireless communication selected from a group consisting of radio frequency communication, microwave communication, or infrared communication.

In another embodiment the system can have a i.) hand held device having an application program wherein the hand held device allows a merchant device to locate the hand held device from a hand held device user and ii.) a merchant device having an application program wherein the merchant device allows the merchant device to locate the hand held device. The merchant device can provide a charge and the hand held device can provide a payment for the charge. The charge can be automatically paid when the hand held device is located by the merchant device. The charge can be selected from the group consisting of services, products, or goods. The merchant device can locate the hand held device within 300 feet.

The merchant device can have a code and the hand held device can also have the code, wherein the merchant device identifies the code of the hand held device. The merchant device can be located in a brick and mortar. The brand of the hand held device can be selected from a group consisting of iphone, blackberry, or palm. The payment for the charge can be withdrawn from an account owned from a user of the hand held device. The merchant device stores a customer profile. The merchant device provides a charge for payment to the hand held device according to a customer profile of a owner of the hand held device. The charge can be automatically paid to the merchant device. The merchant device can locate the hand held device through wireless communication. The wireless communication can be selected from a group consisting of radio frequency communication, microwave communication, or infrared communication.

In another embodiment the system comprises i.) an apparatus for locating a hand held device, comprising an application programming interface (API), executed by a merchant device, for providing a plurality of simplified procedures that allow an application program executed by a computer to locate the hand held device, wherein:
(a) the application program invokes the simplified procedures of the API; and
(b) the invoked procedures obtain:
   (i) a location of the hand held device given an identification of the hand held device, wherein:
      (1) the invoked procedures are configured to interact with specifics for two or more mobile positioning servers for carriers of two or more hand held devices; and
      (2) the invoked procedures interact with two or more different methods of identifying the hand held devices as required by the different carriers of the hand held devices, and wherein a new different method for identifying the hand held devices may be dynamically deployed and used by the invoked procedures without deploying a new API or new application program;
(ii) a description of a spatial reference system associated with the location wherein the merchant device and the hand held device interact for payment at a location as determined by the spatial reference system and user identifier has account information associated therewith.

The location of the merchant device and the hand held device can be within 1000 feet of one another. The account can have at least one dollar. The account can also be a charge card.

### BRIEF DESCRIPTION OF THE FIGURES

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 shows a system construction of an embodiment of the present invention.

FIG. 2 is an example illustrating a customer profile.

FIG. 3 is a flowchart showing an embodiment of the method for payment in accordance with the present invention.

FIG. 4 shows the communication of the merchant device with the hand held device.

The detailed description explains the preferred embodiments of the invention, together with advantages and features, by way of example with reference to the drawings.

### DETAILED DESCRIPTION OF THE INVENTION

Section A. will provide terms which will assist the reader in best understanding the features of the invention but not to introduce limitations in the terms inconsistent with the context in which they are used in this specification. These definitions are not intended to be limiting. Section B. will discuss the payment system of the present invention.

### SECTION A

### Terms

As used herein, the term “automatic” is when the hand held device and the merchant device communicate with no action from the user at the time of communication (i.e., payment). The user provides permission for their hand held device to communicate with the merchant device before communication occurs.

As used herein, the term “available fund(s)” is a fund or account which holds cash, money, or has the ability to use a credit card to charge for money or funds to be placed into an account. This fund can also be a medium in which goods or services are directly exchanged for other goods and/or services without a medium of exchange, such as money.

As used herein, the term “consumer” is an individual person or other entity that accesses or uses a hand held device to perform certain functions of a mobile financial transaction system (MFTS), in accordance with exemplary aspects of the inventions. Generally, synonymous with user, below.

As used herein, the term “consumer data or profile” is a description of a customer group or type of customer based on various demographic, psychographic and/or geographic characteristics; also called shopper profile. For example, magazine advertising salespeople provide advertisers with customer profiles describing the type of person who will be exposed to advertisements in that magazine. The description may include income, occupation, level of education, age, gender, hobbies, or area of residence. Customer profiles provide the knowledge needed to select the best prospect lists and to enable advertisers to select the best media.

As used herein, the term “hand held device” comprises all communication means which are suitable for wireless voice and data communications, such as a cellular phone, a PCS terminal, an IMT-2000 terminal, or a Personal Digital Assistant (“PDA”) terminal. The held device that can be implemented as a specific type of a hand held device, such as a Personal Digital Assistant (PDA), paging device, WAP-enabled mobile phone, and other associated hand held computing devices well known in the art. When PDAs are deployed, such PDA devices can be further configured with both wireless and wireline communications capabilities, such as those found in cellular telephone units, in accordance with carrying out embodiments of the present invention. Examples of PDA devices that can be utilized in accordance with the method and system of the present invention include the “PalmPilot” PDA, manufactured and sold by Palm Computing, the Handspring Visor, the IBM Workpad, WINDOW CE compatible devices, RIM Blackberry-familysmartphones, Motorola paging devices, and the Symbol SPT-family of PDA-type organizer devices.

As used herein, an “application program” is any program which connects the hand held device and the merchant device to orchestrate and complete a payment transaction. The application program can also be used to determine the location of a specific hand held device using the “hand held locator adapter system” as defined below. A network connects the hand held device executing the appropriate software applications to server computers. Server computers may execute a variety of applications including a server application (e.g., a Web server), a Location Based Service (LBS) application, MapGuide server, and/or services. MapGuide servers and services may be located within or part of server application. The server and its components may also be referred to as a back office system. Such a back office system maintains access to corporate databases, synchronization utilities, etc. The server application is typically a program that runs on a UNIX Apache Web server or Microsoft's Internet Information Server. The service may communicate with a client through a server application such that any additional processing required by a client may be performed by the service.

In a geographic information system (GIS) offering location based services, service may communicate with MapGuide server to obtain needed map data/information. Additionally, service may access map windows files (MWF) to obtain relevant data. MapGuide server (or another application) may also interact with a database management system (DBMS) that may be utilized to retrieve relevant geographical data (such as SDF [Spatial Data Files] data (a special data format for delivering large amounts of data quickly over an intranet or the Internet), raster data, Open DataBase Connectivity (ODBC) data, etc.) from the database.

Further, hand held device may interface with LBS application through an application programming interface (API) that provides a uniform interface for determining a location of hand held device and providing additional location based services. To determine the location of the hand held device, the LBS application may utilize one or more adapters for each of the different protocols of various hand held device carriers. The carriers may also maintain user profile information in one or more databases. The LBS application may also maintain an LBS database for the local storage of information.

Generally, the merchant device, hand held device, and network comprise logic and/or data that is embodied in or retrievable from a device, medium, signal, or carrier, e.g., a data storage device, a data communications device, a remote computer or device coupled to the computer via a network or via another data communications device, etc. Moreover, this logic and/or data, when read, executed, and/or interpreted, results in the steps necessary to implement and/or use the present invention being performed.

Thus, embodiments of the invention may be implemented as a method, apparatus, or article of manufacture using standard programming and/or engineering techniques to produce software, firmware, hardware, or any combination thereof. The term “article of manufacture” (or alternatively, “computer program product”) as used herein is intended to encompass logic and/or data accessible from any computer-readable device, carrier, or media.

Those skilled in the art will recognize many modifications may be made to this exemplary environment without departing from the scope of the present invention. For example, those skilled in the art will recognize that any combination of the above components, or any number of different components, including different logic, data, different peripherals, and different devices, may be used to implement the present invention, so long as similar functions are performed thereby.

As used herein, a “hand held device locator adapter system” is a hand held device locator application executed on a client or a server to determine the location of a specific hand held hand held device client. To determine the location of a hand held device client, a device-specific identification is provided to the device locator. For example, a mobile subscriber international subscriber directory number (MSISDN) (the directory number [e.g., the GSM—global system for mobile communications number] or the number one dials to connect to a GSM subscriber) may be provided to a device locator application. Such an MSISDN may be encoded in a cookie in a wireless application request. Alternatively, a device may be identified by an Internet protocol (IP) address encoded in a request header or may be identified by a pre-stored default in the user profile database. The resulting location provided by the device locator contains the coordinates of the hand held device, the hand held device's spatial reference system (SRS), and information regarding the precision of the coordinates.

The hand held device locator provides an interface for accessing the network-provided location of a hand held device. For hand held devices that provide their own location (such as via a Global Positioning System), the application already has the coordinates of the hand held device and does not need to use the hand held device locator.

The hand held device locator provides users with a unified Application Programming Information (“API”) for determining the location of devices. The device locator retrieves the location of devices from third-party location determination technology (LDT) providers, each of which may support different protocols (e.g., HTTP, HTTPS, etc.). LDT is a general term that describes a carrier network based service that provides device location information to internal and external systems. LDT adapters may be supplied by specific carriers and may be utilized to provide the location information. Any location obtained from a source other than the supplied LDT adapters may still be used throughout GIS applications in any API call that requires a location parameter. As described above, LDT providers/carriers may each support different protocols that may vary with respect to the format of the request, the format of the response, and the accuracy of the response. Some services may only provide a geographic region that the mobile system is within, while others may provide specific coordinates.

The device locator interface (i.e., the API) insulates application code from the specific APIs of individual LDT providers. Application developers do not need to understand provider APIs or protocols. Instead, an LDT adapter translates specific provider APIs into a generic API that is presented to the application as the device locator. The LDT adapter therefore insulates the application from differences in protocols like hypertext transfer protocol (HTTP), secure hypertext transfer protocol (HTTPS), etc. Such an architecture may also support additional LDT providers in the future without changing the application API. An LDT adapter simply needs to be written for the new LDT provider.

In one embodiment, architecture can support a hand held device locator. The architecture can have several layers. Application code in an application layer interfaces through the uniform API with a hand held device locator (e.g., LbsDeviceLocatorManager) in the platform API layer to obtain location information for a hand held device.

The hand held device locator interfaces with individual carrier protocols set forth in specific carrier LDT adapters in internal layer to retrieve location information using carrier specific implementations. The carrier LDT adapters interact with client code that communicates with server code in the remote LDT provider layer.

To query the location of a hand held device, the application code retrieves an instance of a device locator object (e.g., LbsDeviceLocatorManager). The application code may then use the device locator to obtain the location of a device given a device's id or GPS coordinates. As described above, the format of device IDs may vary according to the LDT implementation. If a query for the location of a hand held device fails, the hand held device locator may generate an exception.

If the query is successful, a location object may be returned to the application layer. As described above, the resulting location object may contain a Point/Coordinate object containing the coordinates representing the device's location, an SRS object that describes the associated spatial reference system, and a Precision object that describes the precision of the coordinates.

In one or more embodiments of the invention, a device locator manager provides the API and delegates calls to specific getLocation methods implemented for/by individual carriers. To ensure that the individual carrier implement such a getLocation method, an interface (e.g., a device locator interface) may be implemented by all specific device locator adapters.

In another embodiment, the hand held device can include a “positioning module”, such that the position of the hand held device may be determined from a remote location. The positioning module may preferably include a GPS receiver which is capable of receiving signals from a navigational satellite system such as a GPS. The positioning module may be a type having a very small foot print allowing it to be embedded on hand held devices. One such module may be a GPS receiver based on the SiRFstarIII chip set which is marketed by SiRF Technology Holdings. Other ultra small form factor GPS receivers could be used such as the MN1010 marketed by Micro Modular Technologies, of Singapore. The receiver may further include or be operably connected to an antenna disposed on the housing of hand held device, and tuned to frequencies transmitted by the satellites. The receiver may further include processors, and a highly-stable clock, such as a crystal oscillator.

The positioning module may be operably connected to a power source. The power source may be in the form of a battery such as a rechargeable battery and/or a solar panel. Solar panel may supply power to operate the various components and may be operably connected to the battery to provide a charge. The battery may supply power even when a light source is not available. With the positioning module, antenna, and power source, the hand held device has a capability of determining its location essentially anywhere on earth. In one embodiment, the hand held device may also include a display screen which may indicate the location of the card to a user or other indicia. Appropriate controls could be disposed on the hand held device in a manner known in the art.

The hand held device of the present invention may further include a transmitting module disposed thereon. The transmitting module may be operably connected to the positioning module in such a manner that the location information obtained by the positioning module may be wirelessly transmitted from the hand held device. The transmitting module may be operably connected to the antenna in order to permit signals generated from the transmitting module to be radiated from the hand held device. Alternatively, a separate dedicated transmission antenna may be used.

The hand held device transmits signals which include information relating to the position of the hand held device and the identification information which identifies the specific device and the payment transaction information. The transmitted signals may be picked up by a terrestrial or spaced-based network. For example, the transmitting module may be configured to transmit over a wireless network. The wireless network may be a cellular wireless phone network such as GSM or CDMA network, or over other networks. On a GSM network the information could be sent under the short message service, SMS. These examples are not intended to be limiting, for it is within the contemplation of the present invention that any communication system or network could be employed to carry the position information. By transmitting the information, the location information may be remotely accessed in real time. The transmitting module may include the components known in the art to initiate a transmission over a wireless network and transmit information over that network.

In order to permit location tracking of the hand held device in real time, the transmitted location information may be sent over the wireless network to a tracking terminal. The tracking terminal may include the hand held device issuer's computer system or network. The hand held device issuer may include, for example, a bank, other financial institution or retailer. Such location information may be sent in response to an event. For example, the event may be the use of the hand held device. Therefore each time the hand held device is used in a commercial transaction, such as when the device is interrogated, the location information may be transmitted. Alternatively, the event may be the passage of time wherein the location information is transmitted at predetermined time intervals. In a further alternative embodiment, the event may be a predetermined change in location. Therefore, when the hand held device is brought to a location it would transmit a signal including the location information and it would not transmit again until the location is changed by a predetermined amount. The location information transmitted by the hand held device may be stored along with other information regarding the account corresponding to the hand held device on the issuer's computer system.

In one embodiment, the user may be able to receive communication including location information directly from the wireless system or network. In this embodiment, the hand held device may be able to receive and send messages over the communications network. A user may have the ability to access the location information transmitted by the hand held device on a home PC, via a land line phone, a cell phone or personal digital assistant, or other communication device which in this embodiment form the tracking terminal. The communication with the hand held device may be achieved in a manner similar to communication over a wireless cellular network. The hand held device may include a receiving device, such as that found on a hand held device or pager in order to allow remote communication, in addition to the transmitting module. The receiving device may be operably connected to the antennae or have its own antennae. Upon receiving a signal, the receiving device in conjunction with the transmitting module establish communication with the user and provide the location information.

Upon communication connection to the hand held device either through an issuer's computer system or directly, the hand held device may transmit a message including the location information which provides the physical location of the hand held device along with payment transaction information. The transmission of this information may first require the sending of a password or code. The hand held device's location may then be determined and the hand held device retrieved. In addition, once the location of the hand held device is determined, the user can choose to have the device deactivated if it appears that the device is no longer in the control of the user. Deactivation may be achieved by contacting the issuer of the hand held device who in turn could deactivate the device in a manner well known in the art. Alternatively, a signal could be sent directly to the hand held device over the wireless network which would be interpreted by hardware and/or software on the hand held device to cause the account information element to become inoperative.

GPS tracking software to track the location of the hand held device may be installed into a home PC, cell phone or other type of communication device. Such a device may also be disposed in an automobile. The whereabouts of the hand held device can then be tracked by the user at will in real time by way of the software. Due to the flexibility and ease of use, the user may have immediate access and flexibility in tracking/tracing the whereabouts of their hand held device.

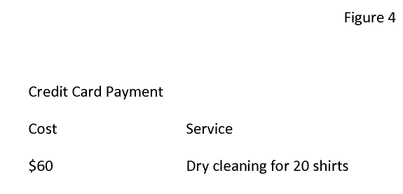

As used herein, “locate” means that the hand held device 12 will communicate with the merchant device 14. The hand held device 12 broadcasts its location coordinates to the server. The merchant device 14 looks for any hand held device 12 that is in its close proximity by evaluating the location coordinates of all hand held devices 12 broadcasts posted to the server. FIG. 4 provides a diagram how this may work. The hand held device 2 and the merchant device 14 can communicate with each in any way known in the art. Each device 2, 14 may transmit information and receive information from the other device 2, 14 while they are not being used. In other words, they will “talk” to each other and the main server. Data can be transmitted from the main server 30 and split into small packets 32. Each device 2, 14 would be able to transmit data as well as receive.

In another embodiment, the consumer can communicate its location longitudinally and latitudinally through its hand held device to the merchant device which is ran by the merchant application. In one embodiment, the location is discovered once the hand held device arrives in a store by the merchant application identifying the hand held device in close proximity of its location. In this embodiment, the number of customers and accordingly their hand held device is narrowed. The merchant application will then send a request payment by creating an e-transaction with the exact amount of the payment requested to the customer which corresponds also to the longitudinally and latitudinally tagged location. This electronic transaction could also include a timestamp. When the consumer is ready to pay for the service and or product, the consumer authorizes the payment by sending the longitudinal and latitudinal location along with the exact amount of payment to the server as an authorization message. The merchant application constantly polls all the authorization messages in close proximity of its location. If the merchant application finds 1 or more hand held devices within the same location that send authorization messages, the list is returned to the merchant application and the employee of the store chooses the correct authorization based on the customer's identify (i.e., name, photo, etc.). After the merchant chooses the correct authorization, an approved message is sent to the server for the consumer. Finally, the consumer hand held device polls for an approved message based on it authorization message

As used herein, “merchant device” means any device or computer system, or processing unit which can receive transmission or communication from a hand held device.

The merchant device may have a housing. The housing may be a fob-type housing including an element which permits it to be attached to another element such as a key ring or lanyard. Alternatively, the housing may be formed without such an element. The housing may include an account information element such as an RFID module which is capable of transmitting account identification information when interrogated by a point of sale device in a manner known in the art. The housing may alternatively include a magnetic strip, bar code, or other device for storing account identification information.

The housing may further include a positioning module and transmitting module. Both modules may be operably connected to each other and to a power source. An antenna may be enclosed in the housing or extending there from for receiving positioning signals and transmitting position information signals. It is within the contemplation of the present invention that the positioning module may be operably connected to a first antenna and the transmitting module may be operably connected to a second antenna (not shown). The hand held device is capable of determining its location through use of the GPS network and transmitting that location. The hand held device may also include a receiving device (not shown) such as described above with respect to merchant device, for receiving communications prompting transmission of location information.

As used herein, “Mobile Financial Transaction System (MFTS)” means a system constructed as described in this document, that facilitates financial transactions by use of hand held devices.

As used herein, “MFTS payment instruction (MFTSPI)” means a form of Payment Instruction (PI) that comprises a communication initiated by the MFTS and transmitted to a payment instruction recipient such as a financial institution to instruct that institution to make a payment to an identified selected entity.

As used herein, “Mobile Payment Instruction (MPI)” means a form of Payment Instruction (PI)(see below) that is generated and provided from a hand held device in accordance with exemplary aspects of the invention.

As used herein, “Security” means any technique for securing electronic data and keeping the electronic data secured at all times on the hand held device and the merchant device. According to one embodiment, a hand held device is configured to provide access control to a secured merchant device that may be located in a local store, another computer machine or somewhere over a data network. The hand held device includes a module configured to operate in a path through which data accessed is caused to pass so that the data can be examined or detected for the security nature. If the data is secured, the module obtains a user or group key to decrypt security information in the data for access rules therein. If a hand held device accessing the data is determined to have the access privilege to the secured data, a file key is retrieved from the security information and a cipher module is activated to decrypt the encrypted data portion with the file key. Likewise, if a document is to be secured, the cipher module encrypts clear data to create the encrypted data portion. The module integrates proper or desired security information with the encrypted data portion to produce the secured document.

As used herein, “User identifier (user ID)” means a code used to identify a user to the MFTS, or to a financial service provider, or to another component that requires information identifying a user for some purpose in connection with the invention.

### SECTION B

### Payment System

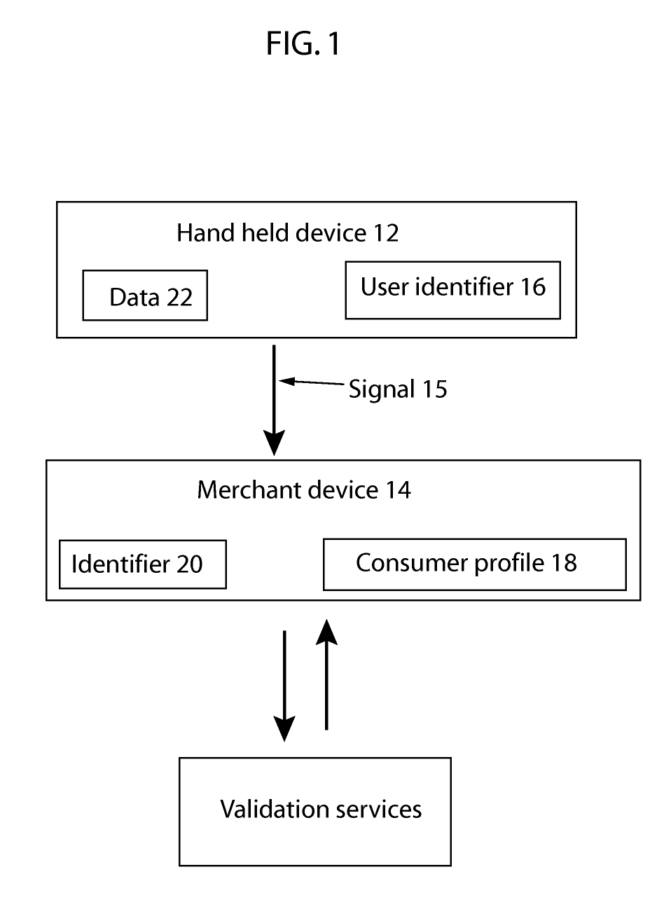

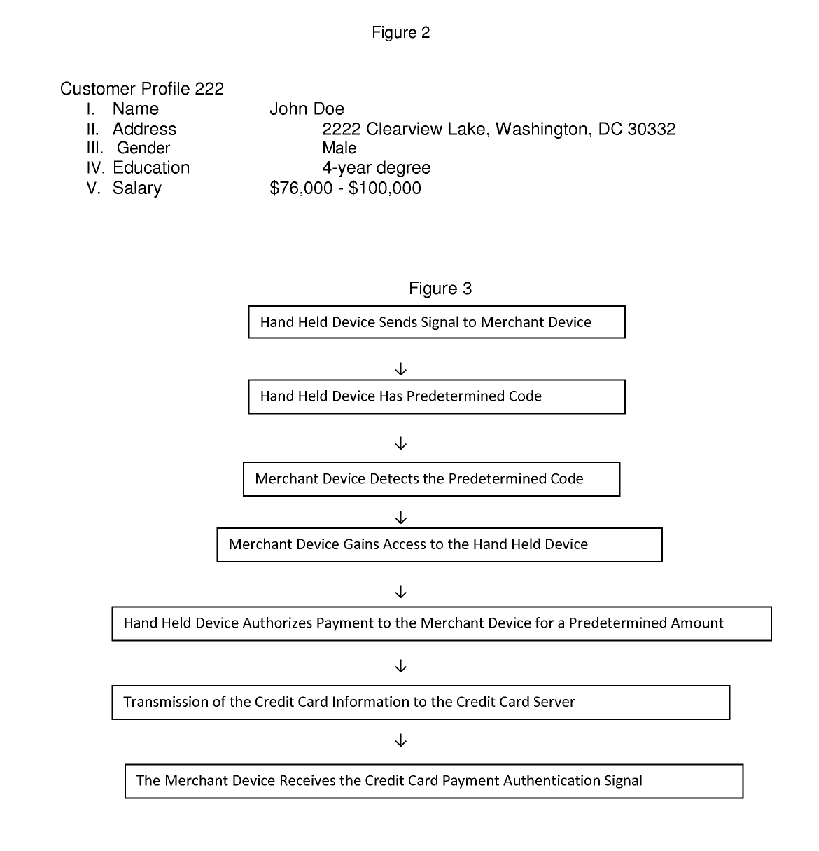

FIG. 1 shows a system construction of an embodiment of the present invention. As shown in FIG. 1, the present invention includes a hand held device 12 which can signal 15 to a merchant device 14. In another embodiment, the merchant device 14 can send a signal 15 to the hand held device 12. The hand held device 12 has a user identifier 16 which the merchant device 14 can detect. When the merchant device 14 detects the hand held device 12 payment is made. In one embodiment, the consumer can approve of the payment before making the payment. In another embodiment, the payment is automatically made from the hand held device 12 to the merchant device 14.

The merchant device 14 is capable of storing a customer profile 18 which can be connected to an identifier 20 of the merchant device 14. In other words the customer profile 18 is linked to the identifier 20. The hand held device 12 is capable of storing data 22 which represents the financial/banking information required for the payment transaction. The merchant device 14 may be connected to an available funds validation device or service 24, which, while connected to merchant device 14, can extract the information necessary for a payment transaction from the data 22 as it is read by the merchant device 14, transmits the information to the available funds validation device or service 24 and receive a payment authentication.

FIG. 3 is a flowchart showing an embodiment of the method for a mobile payment transaction in accordance with the present invention. First, a hand held device 12 sends a signal to the merchant device 14. The hand held device 12 has a location along with the payment transaction information which identifies the hand held device 12 to the merchant device 14. The merchant device 14 initiates a payment request and waits on the payment authorization from hand held device 12. The hand held device 12 authorizes payment for a predetermined amount for services and/or goods. The authorization is automatic and requires no additional input from the consumer. The merchant device 14 identifies the authorization and confirms the authorization against the available funds. The merchant device 14 can then notify the hand held device 12 in the form of a sales receipt. In one embodiment, the consumer registers for an account with the merchant. During this registration, the consumer inputs needed customer profile information, banking/financial information, and automatic authorization of payment when the hand held device communicates with the merchant device. In another embodiment, an additional step of authentication or security such as input of passwords can be installed to ensure trade security.

The present invention also includes a hand held device 12 which can scan items. In this embodiment, the merchant device 14 locates the hand held device 12 and when the consumer is in a certain proximity which is detected either by hand held device locator adapter system 18 or a positioning module 20 payment is made either automatically or with approval from the hand held device 12.

### SECTION C

### Examples

### Example I

A consumer is driving to pick up their dry cleaning clothes. When the consumer is at the dry cleaning store, the consumer's hand held device begins the hand held adapter program which signals to the merchant device that the consumer is close. The dry cleaning merchant locates the consumer's clothes so when the consumer arrives, the dry cleaning merchant can give the clothes to the consumer. The dry cleaning merchant's device initiates the MFTS so that payment for the services can be made. When the consumer comes to the dry cleaning store, the consumer picks up the clothes and saves time by not having to pay for the clothes with a credit card or other form of money.

### Example II

A consumer is grocery shopping. After the consumer is finished shopping, the consumer begins the application program in which the consumer communicates to the merchant device that the grocery shopping is finished. The MFTS is initiated and the items are paid. The consumer exits without having to interact with the merchant device.

### Example III

A consumer's automobile is in need of service. When the consumer is nearby, at least 500 feet away, the consumer's hand held device is detected by the car service. When the consumer's hand held device is detected, the consumer profile is retrieved from the car service system. When the consumer arrives for service, the car service not only identifies the consumer but also identifies the service needed. According to the consumer profile, the car service can also recommend additional service to the consumer in person or communicated through the consumer's hand held device.

### Example IV

A consumer visits a restaurant. The consumer's hand held device is registered so that the restaurant device detects the consumer. When the customer is automatically detected, the restaurant pulls the customer's profile data which reveals the consumer's purchasing habits. The restaurant sends a coupon to the customer according to their purchasing habits. For example, if the customer's profile shows that the customer usually purchases a steak dinner, the restaurant will electronically issue a coupon for a steak dinner. This encourages loyalty to the restaurant.

### Example V

A consumer provides permission to several restaurants to recognize its hand held device. When the consumer enters a range, the consumer can enter a code to grant permission for the restaurants to have access to its hand held device. The hand held device has data which is pulled into the merchant device and provides customized messages according to the customer data which targets the consumer and would ultimately drive them to the merchant.

Although preferred embodiments of the present invention have been described herein with reference to the accompanying drawings, it is to be understood that the invention is not limited to those precise embodiments and that various other changes and modifications may be affected herein by one skilled in the art without departing from the scope or spirit of the invention, and that it is intended to claim all such changes and modifications that fall within the scope of the invention.

All documents cited in the Detailed Description of the Invention are, are, in relevant part, incorporated herein by reference; the citation of any document is not to be construed as an admission that it is prior art with respect to the present invention.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

The capabilities of the present invention can be implemented in software, firmware, hardware or some combination thereof.

As one example, one or more aspects of the present invention can be included in an article of manufacture (e.g., one or more computer program products) having, for instance, computer usable media. The media has embodied therein, for instance, computer readable program code means for providing and facilitating the capabilities of the present invention. The article of manufacture can be included as a part of a computer system or sold separately.

Additionally, at least one program storage device readable by a machine, tangibly embodying at least one program of instructions executable by the machine to perform the capabilities of the present invention can be provided.

The flow diagrams depicted herein are just examples. There may be many variations to these diagrams or the steps (or operations) described therein without departing from the spirit of the invention. For instance, the steps may be performed in a differing order, or steps may be added, deleted or modified. All of these variations are considered a part of the claimed invention.

While the preferred embodiment to the invention has been described, it will be understood that those skilled in the art, both now and in the future, may make various improvements and enhancements which fall within the scope of the claims which follow. These claims should be construed to maintain the proper protection for the invention first described.

What is claimed is:

1. A system comprising:
i. a hand held device having an application program wherein said hand held device allows a merchant device to locate said hand held device and
ii. merchant device having an application program wherein said merchant device allows said merchant device to locate said hand held device.

2. The system according to claim 1 wherein said merchant device locates said hand held device through wireless communication.

3. The system according to claim 1 wherein said wireless communication is selected from a group consisting of radio frequency communication, microwave communication, or infrared communication.

4. A system comprising:
i. hand held device having an application program wherein said hand held device allows a merchant device to locate said hand held device from a hand held device user and
ii. merchant device having an application program wherein said merchant device allows said merchant device to locate said hand held device
iii. wherein said merchant device provides a charge and said hand held device provides a payment for said charge.

5. The system according to claim 2 wherein said charge is automatically paid when said hand held device is located by said merchant device.

6. The system according to claim 2 wherein the charge is selected from the group consisting of services, products, or goods.

7. The system according to claim 2 wherein the merchant device locates said hand held device within 300 feet.

8. The system according to claim 2 wherein the merchant device has a code and said hand held device has said code, wherein said merchant device identifies said code of said hand held device.

9. The system according to claim 2 wherein said merchant device is located in a brick and mortar.

10. The system according to claim 2 wherein a brand of said hand held device is selected from a group consisting of iphone, blackberry, or palm.

11. The system according to claim 2 wherein said payment for said charge is withdrawn from an account owned from a user of said hand held device.

12. The system according to claim 2 wherein said merchant device stores a customer profile.

13. The system according to claim 2 wherein said merchant device provides a charge for payment to said hand held device according to a customer profile of a owner of said hand held device.

14. The system according to claim 11 wherein said charge is automatically paid to the merchant device.

15. The system according to claim 11 wherein said merchant device locates said hand held device through wireless communication.

16. The system according to claim 13 wherein said wireless communication is selected from a group consisting of radio frequency communication, microwave communication, or infrared communication.

17. A system comprising,
i. an apparatus for locating a hand held device, comprising an application programming interface (API), executed by a merchant device, for providing a plurality of simplified procedures that allow an application program executed by a computer to locate the hand held device, wherein:
(a) the application program invokes the simplified procedures of the API; and
(b) the invoked procedures obtain:
(i) a location of the hand held device given an identification of the hand held device, wherein:
(1) the invoked procedures are configured to interact with specifics for two or more mobile positioning servers for carriers of two or more hand held devices; and
(2) the invoked procedures interact with two or more different methods of identifying the hand held devices as required by the different carriers of the hand held devices, and wherein a new different method for identifying the hand held devices may be dynamically deployed and used by the invoked procedures without deploying a new API or new application program;
(ii) a description of a spatial reference system associated with the location
wherein said merchant device and said hand held device interact for payment at a location as determined by the spatial reference system and user identifier has account information associated therewith.

18. The system according to claim 17 wherein said location of said merchant device and said hand held device are within 1000 feet of one another.

19. The system according to claim 17 wherein an account has at least one dollar.

20. The system according to claim 17 wherein an account is a charge card.
